(19) United States
(12) Patent Application Publication
(10) Pub. No.: US 2021/0105539 A1
(43) Pub. Date: Apr. 8, 2021

(54) METHOD AND SYSTEM FOR ESTABLISHING A SCROLLING FAN TICKER FOR A SPORTS BROADCAST

(71) Applicant: Ronald S. Henderson, Fishers, IN (US)

(72) Inventor: Ronald S. Henderson, Fishers, IN (US)

(21) Appl. No.: 17/126,287

(22) Filed: Dec. 18, 2020

Related U.S. Application Data
(63) Continuation of application No. 29/661,143, filed on Aug. 24, 2018, now Pat. No. D907663.
Application No. 29/661,143 is a continuation of application No. 14/152,579, filed on Jan. 10, 2014, now abandoned.

(51) Int. Cl. H04N 21/488; G06Q 30/02; G06Q 20/12; H04N 21/2187; H04N 21/81; H04N 21/44; H04N 21/2543; H04N 7/16; H04N 21/234; H04N 21/414

(52) U.S. Cl. CPC H04N 21/4886; G06Q 30/0255; G06Q 20/127; H04N 21/2187; H04N 21/8126; H04N 21/8133; H04N 21/25435; H04N 7/162; H04N 21/23424; H04N 21/41415; H04N 21/44016

(57) ABSTRACT

A method includes storing, in a database of a computer, information pertaining to subscriptions of subscribers that have signed up to have their names displayed on a scrolling fan ticker during a sports broadcast. The method also includes providing to a television network a list of the names of the subscribers that are to be displayed on the scrolling fan ticker during the sports broadcast.

This application is a continuation of U.S. Design application Ser. No. 29/661,143, filed Aug. 24, 2018, now U.S. Design Pat. No. DXXXXXX, which is a continuation of U.S. application Ser. No. 14/152,579, filed Jan. 10, 2014, now abandoned, each of which is hereby incorporated by reference herein in its entirety.

### BACKGROUND

The present disclosure relates to establishing databases of information to be shown on a ticker during a sports broadcast. The present disclosure also relates to methods of permitting fans to publicly demonstrate their loyalty to a sports organization.

Various types of information are known to be displayed on a ticker during a sports broadcast. The information is typically displayed in a horizontal field located near the top or bottom of a television screen. The field takes up a small portion of the overall area of the television screen with the large majority of the screen being devoted to the sports event being broadcast. The information shown on known sports tickers may include statistics regarding the participants of the sports event being broadcast, scores of other sporting events that are taking place, and news relating to sports organizations or participants, just to same a few. For example, it is common during auto races (e.g., NASCAR, IndyCar, F1, MotoGP, etc.) to list the running order of the drivers in a ticker near the top of the television screen. As another example, the scores of baseball or football games for other games are commonly scrolled across a ticker located near a bottom of the television screen. Accordingly, the viewing public has become accustomed to scrolling tickers that are broadcast along with an associated sporting event. The score of the sports event being broadcast is typically shown in a separate, stationary field on the screen.

Sports fans sometimes demonstrate their loyalty to a team, sport, player, league and the like by purchasing a brick that is inscribed with their name and then placed as part of a sidewalk or plaza, for example, near a sporting venue such as a stadium or arena. Sometimes a statement in addition to the fan's name may be included on the brick. The inscribed bricks may even be used in constructing a sports facility itself. Furthermore, the names of notable fans who have reached a season ticket buying milestone or attendance milestone are sometimes featured in a sports program or magazine that is available at one or more associated sporting events. Featuring fans in this way engenders loyalty to a team by its fans. However, sports organizations such as teams or leagues, may appreciate additional ways to engender fan loyalty.

### SUMMARY

The present application discloses one or more of the features recited in the appended claims and/or the following features which, alone or in any combination, may comprise patentable subject matter:

According to this disclosure, a method may include storing in a database, such as a database of a computer, information pertaining to subscriptions of subscribers that have signed up to have their names displayed on a scrolling fan ticker during a sports broadcast. The method may also include providing to a television network a list of the names of the subscribers that are to be displayed on the scrolling fan ticker during the sports broadcast.

In some embodiments, the method further includes populating the database with information received from a sports organization pertaining to season ticket holders and offering the subscriptions only to the season ticket holders. The sports organization may be a sports league, a sports association, or a sports team. Thus, the sports organization may be a collegiate or professional sports team, sports league, or governing body. For example, college or pro football, basketball, baseball, hockey or soccer teams may provide their list of season ticket holders for inclusion in the database of a computer of an entity that manages the subscriptions. The managing entity then may make the subscriptions available to the season ticket holders for purchase.

The method, therefore, may include contacting the season ticket holders to offer subscriptions. The manner of contacting the season ticket holders to offer subscriptions may include one or more of the following: e-mailing at least some of the season ticket holders, text messaging at least some of the season ticket holders, calling at least some of the season ticket holders using a telephone, and mailing literature to at least some of the season ticket holders. Alternatively or additionally, subscriptions may be offered to the general public.

According to this disclosure, the method may include charging each of the subscribers for their subscriptions. The managing entity may pay the sports organization(s) for the information pertaining to season ticket holders and/or pay the sports organization(s) a percentage of the revenue obtained from each subscriber. The managing entity may also pay the television network to broadcast the list of names of the subscribers on the scrolling fan ticker.

According to this disclosure, the method may include hosting a website that is used by subscribers to establish their subscriptions. The website may include selectable fields for subscribers to establish their subscriptions for one or more sports organizations. For example, a first set of selectable fields may include fields associated with college football, college basketball, college baseball, college soccer, college hockey, professional football, professional basketball, professional baseball, professional soccer, professional hockey, NASCAR, IndyCar, and MotoGP, just to name a few. For some of these fields, once selected, another menu of associated sports teams may appear. The subscriber then selects the field of the associated sports team. The subscriber enters their name, such as first name, last name, and middle initial as it is to appear during the sports broadcast. Other information may also be obtained from the subscriber such as e-mail address or home address, for example. The website may also include appropriate fields for the subscriber to pay for their subscription, such as by credit card, for example.

According to some embodiments, the subscriptions may include a general subscription offered at a first amount and a premium subscription offered at a second amount. It is contemplated by this disclosure that the second amount is larger than the first amount. It is also contemplated by this disclosure that the premium subscriptions occupy a larger area on the scrolling fan ticker. The premium subscriptions may be purchased by celebrities or fraternal organizations, for example. Such a premium subscription may be desirable for celebrities who are known to support a particular sports team (e.g., Spike Lee in connection with the New York Knicks professional basketball team). Having a celebrity name scrolling on the fan ticker of an associated sports team keeps the celebrities' name in the eye of the public and thus, serves as publicity for the celebrity in addition to showing the celebrities' support for their team of choice. A premium subscription also may of interest to fraternal organizations such as fraternities and sororities for college teams, for example. Different pricing levels may be established for different premium subscription types such that the subscription amounts for celebrities and fraternal organizations may differ.

It is contemplated by this disclosure that an electronic flag is stored in the database to indicate that an associated subscription is a premium subscription and/or to indicate the type of premium subscription. The flag may take the form of a code such as a letter or number or word containing alphanumeric characters, for example. The flag may be provided to the television network along with the name of the premium subscriber so that the television network is able to use the flag to create the larger area on the scrolling fan ticker in which the associated premium subscriber's name appears. Flags of this type may also be included in the database for the general subscriptions to indicate that they are general subscriptions.

According to this disclosure, the method may include providing to a television network a first list of subscribers to be displayed on a first scrolling fan ticker associated with a first team of a sporting contest and providing a second list of subscribers to be displayed on a second scrolling fan ticker associated with a second team of the sporting contest. Thus, the fans of two competing teams may be shown on two scrolling fan tickers. The two scrolling fan tickers may be shown simultaneously during a sports broadcast, for example. The names on the two tickers may scroll in the same direction in some embodiments and in opposite directions in other embodiments. The two fan tickers may be broadcast adjacent to each other or separated from each other, such as being on opposite sides or being on top and bottom of the broadcast image.

According to some embodiments, the first and second lists of subscribers are provided to the television network in an electronic spread sheet with the first list being associated with a first tab of the spread sheet and the second list being associated with a second tab of the spread sheet. However, other types of electronic lists are contemplated by this disclosure. The lists may be provided in separate Word documents, for example. It is also within the scope of this disclosure that the lists for all teams in a sports league (e.g., NFL, NBA, MLB) be provided to a television broadcaster in a single spread sheet rather than providing a spread sheet that includes two contestants of a particular game. Thus, the method may include providing to the television network an electronic spread sheet with a plurality of tabs, each tab of the plurality of tabs of the spread sheet being selected to obtain the list of subscribers associated with a particular sports team of a sports league. The broadcaster then selects the fan ticker lists based on the contestants on a game-by-game basis from the “master” spread sheet having the fan ticker lists for all teams in the league. Accordingly, it will be appreciated that the master spread sheet or other list is provided to one or more television networks at the beginning of a sports season for use throughout the season. The master list may be used during the playoffs or tournament or, in some embodiments, a separate subscription must be obtained by the fans to have their names included on the fan ticker during the associated playoffs or tournament.

It is also contemplated by this disclosure that the above-described features may be performed by a governing entity of a sports league. Thus, it would be possible for governing bodies such as the NCAA, NBA, NFL, MLB, Indy Car, etc. to offer the fan ticker subscriptions, receive the subscriptions from fans, and provide the lists of subscribers to television networks for broadcast on the fan ticker. In such cases, the governing entity serves as the managing entity for the fan ticker database.

Due to the fact that sports broadcasts are time limited, the number of available subscriptions may be limited. Accordingly, if there is more demand to become a subscriber than there are available subscription slots, it is within the scope of this disclosure that the method may include auctioning the subscriptions based on bid amounts. Thus, a subscription to be listed on the fan ticker of one team may cost more for than another team depending upon the amount demand by the fans to be listed. Alternatively or additionally, the pricing may be adjusted from season to season based on demand. Subscriptions may also be offered on a first come, first served basis according to this disclosure.

Further according to this disclosure, the method may include providing to at least one subscriber a still image showing the name of the subscriber as broadcast by the television network on the scrolling fan ticker during the sports broadcast. For example, the still image may be e-mailed to the at least one subscriber. Such images may be e-mailed to all subscribers for which there is an e-mail address provided during the subscription process. This provides the fans receiving the still images with proof that their name had been included on the fan ticker during the sports broadcast. Alternatively or additionally, providing the still image may include mailing a framed or mounted image that has been purchased by the at least one subscriber. Such framed or mounted images may be marketed to the subscribers as part of, or separately from, the e-mail that includes the still image.

Additional features, which alone or in combination with any other feature(s), such as those listed above and those listed in the claims, may comprise patentable subject matter and will become apparent to those skilled in the art upon consideration of the following detailed description of various embodiments exemplifying the best mode of carrying out the embodiments as presently perceived.

### BRIEF DESCRIPTION OF THE DRAWINGS

The detailed description particularly refers to the accompanying figures in which:

FIG. 1 is a block diagram showing a name collection website having a database of season ticket holders as provided by a number of sports organizations, showing databases of information regarding subscriptions of fans of a number of sports teams, and showing the subscription information being provided to television networks for inclusion on a scrolling fan ticker that is included as part of a sports broadcast;

FIG. 2 is a flow chart showing various steps of operation of the name collection website;

FIG. 3 is a screen shot showing an example of two horizontally oriented scrolling fan tickers being broadcast during a game, the scrolling fan tickers being at the top of the screen, a first of the scrolling fan tickers being associated with one of the teams competing in the game, and the second of the scrolling fan tickers being associated with the other of the teams competing in the game;

FIG. 4 is a screen shot, similar to FIG. 3, showing the scrolling fan tickers being oriented vertically on opposite sides of the sports broadcast;

FIG. 5 is a screen shot, similar to FIG. 3, showing blocks for advertisements on the opposite sides of the screen;

FIG. 6 is a screen shot, similar to FIG. 4, showing a block for advertisements at the top of the screen;

FIG. 7 is a screen shot showing a scrolling fan ticker at the bottom of the screen of a broadcast of a race with a driver running order ticker being shown at the top of the screen;

FIG. 8 is a screen shot, similar to FIG. 7, showing the scrolling fan ticker situated just beneath the driver running order ticker;

FIG. 9 is a screen shot showing an enlarged celebrity name block being included as part of the scrolling fan ticker; and

FIG. 10 is a screen showing vertically oriented scrolling fan tickers on opposite sides of the screen each including an enlarged celebrity name block.

### DETAILED DESCRIPTION

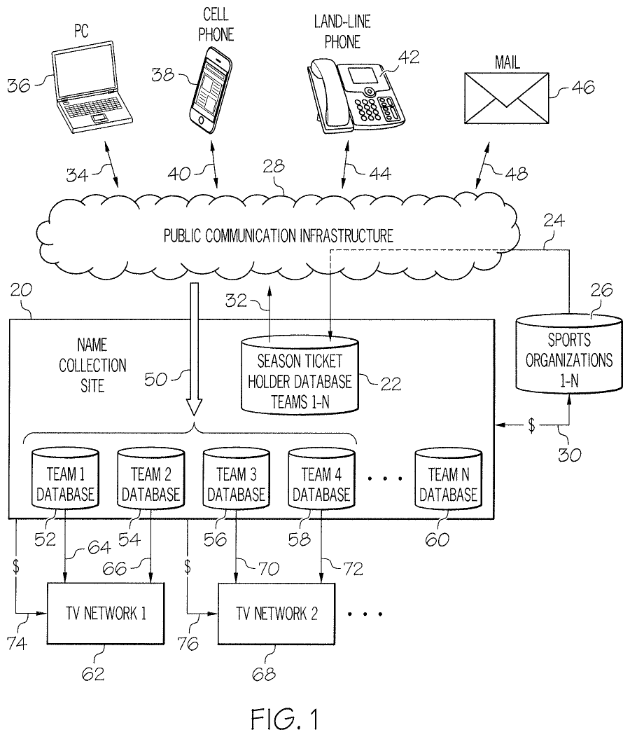

According to the present disclosure, a name collection site 20 includes computer devices, such as personal computers or servers, having a season ticket holder database 22 as shown in FIG. 1. Names and contact information for season ticket holders are stored in database 22. The contact information includes, for example, one or more of e-mail addresses, mailing addresses, telephone numbers, and cell phone numbers. As indicated diagrammatically in FIG. 1 by arrow 24, sports organizations that, illustratively, are 1-N in number, each have databases 26 of season ticket holder information that is provided to the entity managing site 20. The season ticket holder information is provided from the sports organizations to site 20 using public communication infrastructure 28. Thus, the sports organizations mail the information from database 26 through the postal system in some embodiments and/or e-mail the information from database 26 via the Internet in some embodiments. Hand delivery of a copy of the information from database 26 on a compact disc (CD) or other memory device such as a thumb drive, for example, is also within the scope of this disclosure.

As indicated diagrammatically by double headed arrow 30 in FIG. 1, in some embodiments, the entity managing site 20 pays the various sports organizations 1-N or sports league governing bodies for the information in their databases 26. Alternatively or additionally, the sports organizations having respective databases 26 pay a fee to the managing entity of site 20 to populate and manage database 22 and to perform the other tasks described herein as being associated with site 20. As database 22 becomes populated with information regarding the season ticket holders of a sports organization, such as a team, conference, league, etc., the individual season ticket holders are contacted by the entity managing 20, as indicated diagrammatically in FIG. 1 by arrow 32, and are offered subscriptions to have their names shown on a scrolling fan ticker during a sports broadcast as will be described in further detail below.

It is contemplated herein that the communication between the entity managing site 20 and the season ticket holders may be accomplished in any number of ways. For example, e-mails sent to and from a season ticket holder's personal computer 36, as indicated diagrammatically by double headed arrow 34 in FIG. 1, or text messages sent to and from a season ticket holder's cell phone 38, as indicated diagrammatically by double headed arrow 40 are within the scope of this disclosure. Alternatively or additionally, the communication may be accomplished by calling a telephone 42 of one or more of the season ticket holders, as indicated diagrammatically by double headed arrow 44, or by sending and receiving mail 46 as indicated diagrammatically by double headed arrow 48. Combinations of these communication methods are within the scope of this disclosure. For example, a subscription form may be e-mailed to the season ticket holders, printed out, filled out, and returned by mail. The personal computers 36 and/or cell phones 38 and/or other computerized communication devices (e.g., tablets, web enabled video game controllers, etc.) are used to navigate to webpages of site 20, in some embodiments, and the season ticket holders fill out fields on the webpages of site 20 to establish their subscriptions.

Regardless of the communication method used, individual season ticket holders who are interested in having their names included on the scrolling fan ticker provide their information to site 20 and pay a subscription fee to the entity managing site 20 for their subscriptions as indicated by arrow 50 in FIG. 1. The information obtained from the subscribers during the subscription process includes, for example, the subscriber's name and contact information including, for example, e-mail address, mailing address, telephone number and/cell phone number. In some embodiments, not all of this information needs to be obtained from the subscriber, particularly, if that information is already present in database 22. In such instances, once a known person from database 22 subscribes, the information associated with that known person is copied over to the subscription database for the associated team of which that known person is a season ticket holder.

As just alluded to, for team sports, each subscriber is associated with a particular sports team for whom that subscriber is a fan. Site 20 includes team databases that are established for each sports team in a particular league. Thus, in the illustrative example of FIG. 1, generic databases including a team 1 database 52, a team 2 database 54, a team 3 database 56, a team 4 database 58 and a team N database 60 are shown. The databases associated with particular sports leagues are related in site 20. Thus, to use one example, there are 32 teams in the NFL and each team has its own database in site 20. Site 20 populates the team databases 52, 54, 56, 58, 60 (e.g., up to 32 team databases for the NFL) with the information associated with the subscribers for each of the teams. In some embodiments, a spread sheet is used to manage the subscriber information. In such embodiments, for example, each tab of the spread sheet corresponds to a team of the associated league. Separate spread sheets are provided for the various sports leagues (NBA, MLB, MLS, NCAA basketball, NCAA football, etc.).

The entity managing site 20 provides to television networks the lists of names of each of the subscribers for each of the teams that will be participating in a sports contest. In the diagrammatic FIG. 1 example, the subscriber names from the team 1 database 52 and the team 2 database 54 are provided to TV network 1 62 as indicated by respective arrows 64, 66 and the subscriber names from the team 3 database 56 and the team 4 database 58 are provided to TV network 2 68 as indicated by respective arrows 70, 72. Thus, in the illustrative example, team 1 will be competing against team 2 and the sports contest will be broadcast on TV network 1 62. Similarly, team 3 will be competing against team 4 and the sports contest will be broadcast on TV network 2 68. In order to entice television networks to include a scrolling fan ticker during a sports broadcast in some embodiments, a fee is paid to the networks from the entity managing site 20 as shown diagrammatically in FIG. 1 with arrows 74, 76. Alternatively or additionally, a sports league may, as part of negotiating a contract with one or more networks regarding the rights to broadcast the sports event of the league, require the network(s) to include the scrolling fan ticker(s) as part of the broadcast. In such embodiments, the fee payments indicated by arrows 74, 76 are non-existent.

The lists of subscriber names included in databases 52, 54, 56, 58 are e-mailed to TV Network 1 62 and TV Network 2 68 in some embodiments. For example, a Word document or spread sheet containing the lists of names from databases 52, 54, 56, 58 are attached to an e-mail in some embodiments. In other embodiments, the lists are included in the body of the e-mail. In still other embodiments, the lists are provided to the TV networks on CD or memory device. The lists of names are arranged in alphabetical order by last name in some embodiments. However, this need not be the case.

It is contemplated by this disclosure that the lists from databases 52, 54, 56, 58 are provided to TV Networks 1 and 2 62, 68 on a game-by-game basis in some embodiments. This would be preferable, for example, if the databases 52, 54, 56, 58, are not completely full and names will be added over the course of the season. Alternatively or additionally, the entity managing site 20 provides TV Networks 1 and 2 62, 68 the lists of the subscriber names for all of the teams in a sports league at the beginning of the season and then the TV Networks 1 and 2 62, 68 simply use the names associated with the respective teams of a sports contest as the games or other similar sports events are broadcast. This would be preferable, for example, if the databases for all of the teams in a league are full. For a database to be “full,” it means that the maximum number of subscriber names that can feasibly be broadcast on the fan ticker during the length of a typical sports broadcast are included in the database. For example, a typical college basketball game may be expected to last approximately two hours, but half hour of that time may be commercials. If a name is to appear on the scrolling fan ticker for, say three seconds so as to be discernible to the subscribers while watching the game, and at any given time, an average of four subscriber names appear on the scrolling fan ticker, then each team in a college basketball contest should only have about 7,200 subscribers maximum (i.e., 90 minutes=5,400 seconds/3 second name duration=1,800×4 names shown at once=7,200 maximum number of subscribers). Similar calculations can be made for sports broadcasts of differing durations. Also, if each name appears on the screen for a lesser amount of time, then more names can be shown over the course of the sports broadcast of a given duration. Furthermore, if the font size at which the names are broadcast is made smaller, a larger average number than 4 names may possibly be shown at the same time on the scrolling fan ticker.

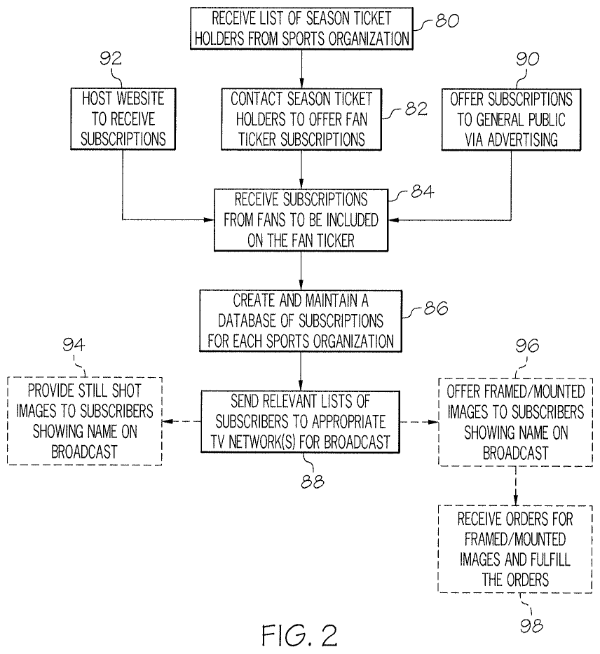

Referring now to FIG. 2, the process described above in connection with site 20 of FIG. 1 is represented by steps shown in blocks 80, 82, 84,86, 88. At block 80, site 20 receives a list of season ticket holders from one or more sports organizations. At block 82, season ticket holders are contacted and are offered subscriptions to have their names included on a fan ticker during a sports broadcast. At block 84, site 20 receives subscriptions from interested fans who wish to be included on the fan ticker. At block 86, databases of subscriptions for each sports organization are created and maintained by site 20 and/or employees of the entity managing site 20. At block 88, the relevant lists of subscribers for sports organizations are sent to television networks for broadcast on the scrolling fan ticker.

According to some embodiments contemplated by this disclosure, subscriptions are offered to the general public via advertising such as television commercials, billboard advertising, magazine advertising, web site advertising, e-mail marketing campaigns, etc., as indicated at block 90. As indicated at block 92, a website such as site 20 is hosted for the season ticket holders and/or the general public and allows the users of the website to enter the relevant information such as name and contact information to subscribe to one or more of the fan tickers of their choosing.

Optionally, the entity managing site 20 provides still shot images to some or all of the subscribers showing the subscribers name as it appeared on the scrolling fan ticker during the sports broadcast as indicated at block 94. This can be accomplished by e-mailing the still shot image to the e-mail addresses provided by the subscribers or by sending a web link to the subscribers for selection by the subscriber to see the image which is otherwise stored in a computer device of site 20. Such messages or web links are sent to the cell phones 38 of subscribers in lieu of, or in addition to, sending the messages or web links to the computers 36 of the subscribers by e-mail. By providing still shot images in the above-described manner, subscribers are able to verify that their name appeared on the scrolling fan ticker during the sports broadcast.

Further optionally, the entity managing site 20 offers framed or mounted images to the subscribers showing each of the subscriber's names as they appeared on the scrolling fan ticker during the sports broadcast as indicated at block 96 of FIG. 2. Such offers are included in e-mail messages or cell phone texts in some embodiments. Alternatively or additionally, the framed or mounted images are offered to the subscribers on the website 20 or via mail 46. As indicated at block 98, site 20 receives orders for the framed or mounted images and fulfills the orders. The subscribers placing the orders pay an extra fee which varies depending upon the size and style of the framed or mounted image that is ordered. In some embodiments, a revenue sharing arrangement is entered into with the sports leagues or sports organizations and, if necessary, with the television networks in exchange for use of the still images obtained from the original sports broadcast that included the scrolling fan ticker or tickers.

The framed images are typically provided in picture frames. The mounted images, however, may be mounted on any type of substrate. For example, the mounted images are mounted on a wooden or metal plaque in some embodiments. Images printed on other substrates such as cloth material (e.g., T-shirts or jackets) or on leather (e.g., game balls) or on paper or card stock, including stickers, are within the scope of this disclosure. Thus, blocks 96, 98 of FIG. 2 are intended to represent all types of memorabilia purchased from site 20 on which a subscriber may wish to have an image from the game broadcast showing their name on the fan ticker.

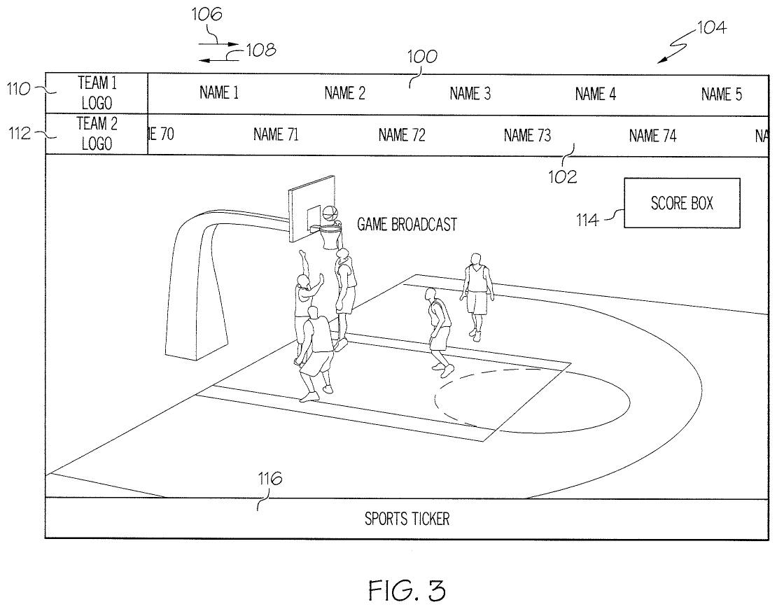

Referring now to FIG. 3, one example of how a first scrolling fan ticker 100 and a second scrolling fan ticker 102 appear on a television screen 104 during a sports broadcast is shown. Tickers 100, 102 are shown at the top of the television screen 104 and the names scroll horizontally across the screen 104 within the tickers 100, 102. The names are shown generically in FIG. 3 as Name 1, Name 2, . . . Name 73, Name 74, and so on. It should be understood that, in practice, the subscribers' names as provided in the databases 52, 54, 56, etc. that are sent to the television networks are what appears within tickers 100, 102. In the FIG. 3 example, ticker 100 scrolls in one direction as indicated diagrammatically with arrow 106 and ticker 102 scrolls in an opposite direction as indicated diagrammatically with arrow 108. More particularly, in the FIG. 3 example, ticker 100 scrolls from left to right and ticker 102 scrolls from right to left. In other embodiments, tickers 100, 102 scroll in the same direction.

In the illustrative FIG. 3 example, a team 1 logo box 110 is provided horizontally adjacent to ticker 100 and a team 2 logo box 112 is provided horizontally adjacent to ticker 102. While the illustrative boxes 110, 112 indicate the team logos generically, in practice, the actual team 1 and team 2 logos appear in boxes 110, 112 respectively. Thus, the team logos in boxes 110, 112 provide the viewers with information regarding which ticker 100, 102 is associated with which team participating in the sports contest being broadcast. In some embodiments, textual information appears in boxes 110, 112, either in addition to or in lieu of the team logos, to convey information to the viewer regarding which ticker 100, 102 is associated with which team. Boxes 110, 112 remain stationary on screen 104 as the names in tickers 100, 102 scroll. In the illustrative example, boxes 110, 112 are shown to the left of tickers 100, 102 but in other embodiments, boxes 110, 112 are located to the right of tickers 100, 102. In still other embodiments, boxes 110, 112 are omitted and the field of tickers 100, 102 over which the subscriber names scroll have team names or logos as “wall paper” of the respective ticker 100, 102. In yet another embodiment, a team logo may scroll on the tickers 100, 102 with the subscriber names and be provided in between each of the names or between every other name or between every third or fourth name in the sequence or in any other desired manner of scrolling.

Screen 104 also has a score box 114 in which the score of the sports contest is displayed as is well known. Also in the illustrative example, a regular sports ticker 116 (e.g., showing scores of other games or showing statistics of the participants of the sports contest or showing other types of sports data) is also shown on screen 104. While it is contemplated that tickers 100, 102 typically appear on screen 104 substantially throughout the entirety of the sports broadcast, ticker 116 appears on screen 104 intermittently in some embodiments. That's not to say that ticker 116 may not be shown throughout the entirety of the sports broadcast if desired or that tickers 100, 102 are shown intermittently.

As is apparent in FIG. 3, the game broadcast of the sporting event occupies the majority of screen 104. In the illustrative example, the vertical height of each of tickers 100, 102 is approximately the same as the vertical height of ticker 116. In other embodiments, the vertical heights of tickers 100, 102 are smaller or larger than the vertical height of ticker 116. For example, in one embodiment the combined vertical height of tickers 100, 102 is about the same as the vertical height of ticker 116. Thus, each ticker 100, 102 is only about half the height of ticker 116 in such embodiments. Viewers who are not subscribers and who will not have their names shown on either of tickers 100, 102 generally will have a preference that tickers 100, 102 be as small and unobtrusive into the image of the game being broadcast as possible while the subscribers may have a preference for the size of the tickers 100, 102 to be larger. So, a tradeoff between the size preferences for tickers 100, 102 between these two sets of viewers needs to be made. Of course, the names appearing on tickers 100, 102 must be sufficiently large as to be readable from a reasonable viewing distance.

Further according to some embodiments of this disclosure, it is contemplated that the tickers 100, 102 become part of the original sports broadcast whereas ticker 116 may or may not. Thus, in the future, when the sporting event is rebroadcast, the names of the subscribers are shown in the rebroadcast. In such embodiments, the probability that the subscribers will watch the replay is increased. In turn, this increases the incentive for television networks to include tickers 100, 102 in the original sports broadcast because the replay viewership may be increased when the broadcast is replayed in the future. Furthermore, the fact that the names in tickers 100, 102 are shown again in future broadcasts increases the incentives for subscribers to pay for a subscription in the first place.

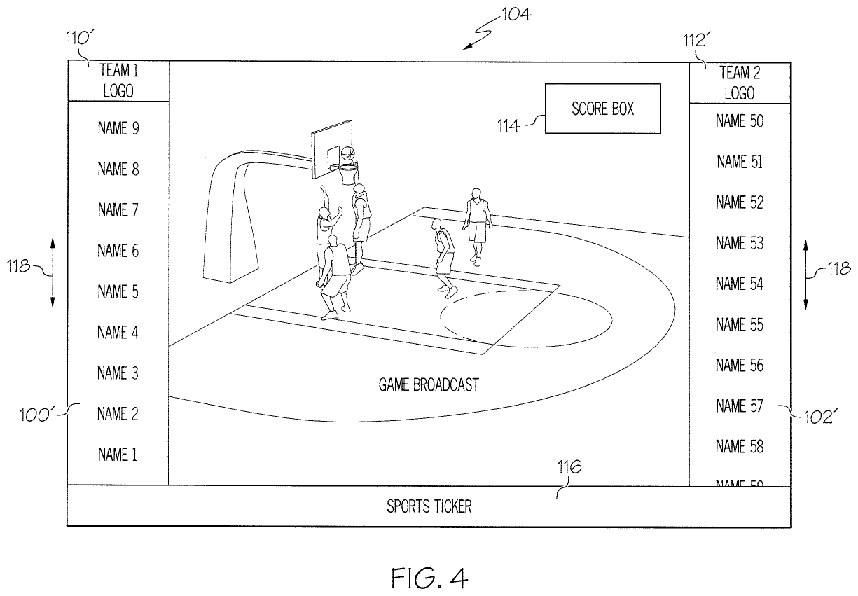

Referring now to FIG. 4, another example of how a first scrolling fan ticker 100′ and a second scrolling fan ticker 102′ appear on a television screen 104 during a sports broadcast is shown. Tickers 100′, 102′ are shown at the opposite sides of the television screen 104 and the names scroll vertically across the screen 104 within the tickers 100′, 102′. As was the case with the FIG. 3 example, the names are shown generically in FIG. 4 as Name 1, Name 2, . . . Name 73, Name 74, and so on but, in practice, the subscribers' actual names as stored in the associated database appear within tickers 100′, 102′. As indicated by double headed arrows 118, tickers 100′, 102′ can scroll upwardly or downwardly, as desired. For example, one of tickers 100′, 102′ may scroll up and the other may scroll down, or they both may scroll in the same direction.

In the illustrative FIG. 4 example, a team 1 logo box 110′ is provided vertically above ticker 100′ and a team 2 logo box 112′ is provided vertically above ticker 102′. In other embodiments one or both of boxes 110′, 112′ are located vertically beneath tickers 100′, 102′. All of the various features and alternatives described above for indicating which ticker 100, 102 goes with which team is equally applicable to tickers 100′, 102′ and need not be repeated here.

As is apparent in the FIG. 4 example, tickers 100′, 102′ take up more area of the overall screen 104 than did tickers 100, 102 of the FIG. 3 example. Also, even though tickers 100′, 102′ are oriented vertically on screen 104, the names within the tickers 100′, 102′ are oriented horizontally in the illustrative example. Depending upon the length of the subscriber's name, two or three lines may be needed to fit the name within the width allocated for the respective ticker 100′, 102′. Nonetheless, it should be understood that more subscriber's names are able to appear on vertical tickers 100′, 102′ at any instant in time than are able to appear on horizontal tickers 100, 102. Accordingly, by having the fan tickers 100′, 102′ oriented vertically, the maximum number of subscriber's may be increased. In variant embodiments, the scrolling fan names are oriented vertically within vertical tickers 100′, 102′ and, in such embodiments, it is possible to reduce the horizontal width of each of the vertical tickers.

In some embodiments contemplated by this disclosure, horizontal tickers 100, 102 are shown on screen 104 during some parts of the sports broadcast, such as during live game action, and vertical tickers 100′, 102′ are shown on screen 104 during other parts of the sports broadcast, such as during half time. Thus, the amount of area of screen 104 on which the game broadcast appears is larger during the live action and smaller during half time. However, while tickers 100′, 102′ are being shown on screen 104, more names are able to fit onto tickers 100′, 102′ at the same time thereby increasing the amount of names that can be shown during the broadcast.

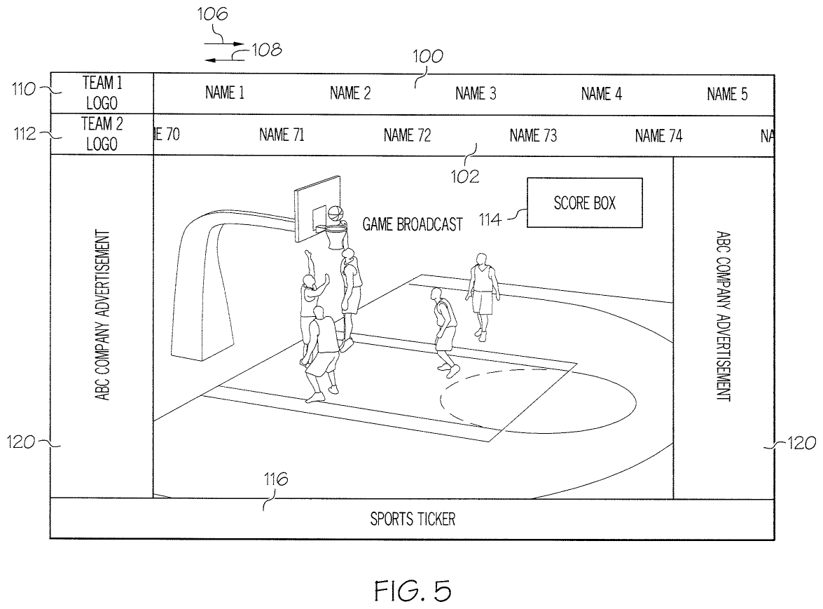

Referring now to FIG. 5, an example similar to FIG. 3 is shown and so like reference numbers are used to denote like portions. However, in the FIG. 5 example, the horizontal to vertical aspect ratio of the portion of screen 104 showing the game broadcast image is kept the same as if tickers 100, 102 and 116 were absent. In other words, the horizontal to vertical aspect ratio of the game broadcast image is equal to that of the entirety of screen 104 of the associated TV screen. Some typical televisions have an aspect ratio of 4:3 or, for widescreen TV's (e.g., widescreen HDTV's), an aspect ratio of 16:9 is typical. By keeping the aspect ratio of the game broadcast image equivalent when tickers 100, 102 and, in the illustrative example, ticker 116 are included on screen 104, vertical boxes 120 result on opposite sides of the game broadcast image. In other embodiments, the game broadcast image is shifted all the way to the right or all the way to the left on screen 104 such that only one of boxes 120, albeit a larger one, appears on one of the sides of the game broadcast image.

In the FIG. 5 example, boxes 120 are used for advertising. Thus, the television network is able to generate further advertising revenue from businesses that wish to advertise within boxes 120 during the game broadcast. This provides yet another incentive for the television networks to include tickers 100, 102 in the overall broadcast. In other embodiments, subscriber names are also scrolled in boxes 120 such as by having fan names associated with one of the teams scrolling in one of boxes 120 and having fan names associated with the other of the teams scrolling in the other box 120. The fan names are oriented horizontally in boxes 120 in some such embodiments. Optionally, each box 120 is divided into two vertical strips and then names associated with each respective team are displayed in the side-by-side strips on either side of the game broadcast. The fan names are oriented vertically within boxes 120 in some such embodiments.

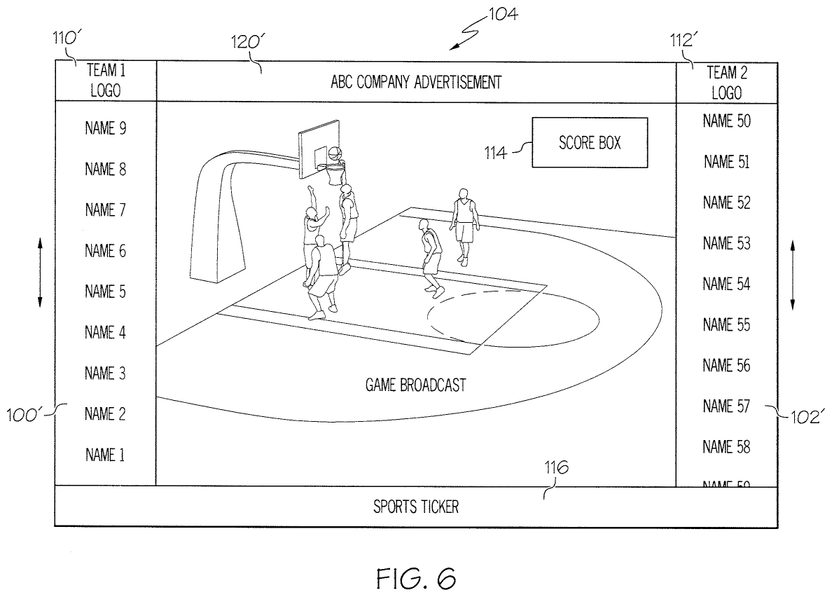

Referring now to FIG. 6, an example similar to FIG. 4 is shown and so like reference numbers are used to denote like portions. However, in the FIG. 6 example, the horizontal to vertical aspect ratio of the portion of screen 104 showing the game broadcast image is kept the same as if tickers 100′, 102′ and 116 were absent. In other words, the horizontal to vertical aspect ratio of the game broadcast image is equal to that of the entirety of screen 104. By keeping the aspect ratio of the game broadcast image equivalent when tickers 100′, 102′ and, in the illustrative example, ticker 116 are included on screen 104, a horizontal box 120′ results above the game broadcast image. In other embodiments, the game broadcast image is shifted upwardly and box 120′ appears beneath the game broadcast image. Alternatively or additionally, ticker 116 is omitted such that one box 120′ appears above the game broadcast image and another beneath the game broadcast image. In the FIG. 6 example, box 120′ is used for advertising which, as mentioned above, is a further source of revenue for the television network.

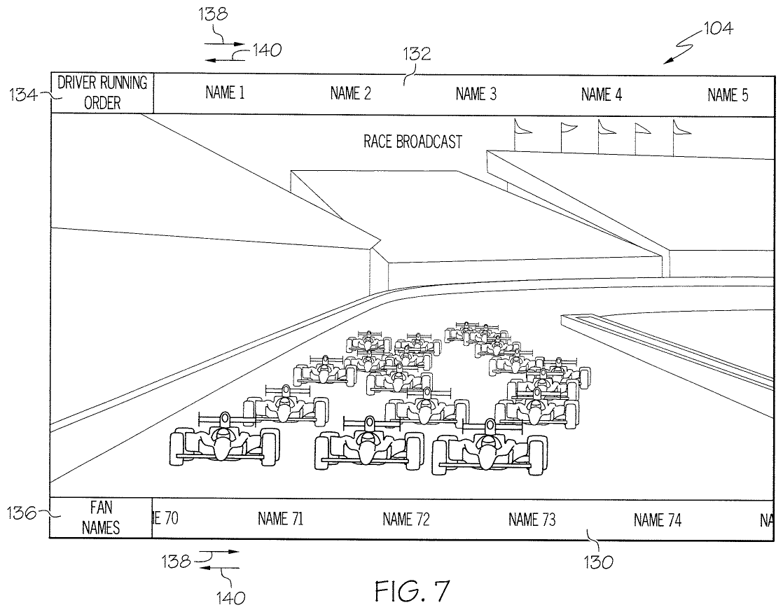

In the examples of FIGS. 3-6, a sporting contest having two teams playing against each other is shown, particularly, a basketball game. FIGS. 3-6 could have just as easily shown a football game, a baseball game, a hockey game or a soccer match, for example. Of course, there are other sports in which a multitude of contestants participate. Examples include golf, gymnastics, track and field, bicycle racing and automotive racing. Accordingly, it is generally not feasible to have a fan ticker for each contestant in such multi-contestant sports. However, fans of the overall sport may still be interested in having their names included on a single fan ticker. For example, in FIG. 7, an automotive car race is shown (e.g., an IndyCar or Formula 1 race) with a scrolling fan ticker 130 at the bottom of screen 104. Thus, the subscribers whose names appear in ticker 130 are fans of the racing league (e.g., IndyCare or NASCAR, etc.), in general, although each fan may have a favorite driver.

It is within the scope of this disclosure for a driver's car number or even a driver's name to be scrolled adjacent to one or more of the names scrolling in ticker 130. For example, the fan's name may be in certain size font on ticker 130 and then their favorite driver's name may appear just beneath the fan's name in ticker 130 with a smaller font. Alternatively or additionally, the driver's car number appears horizontally adjacent to the fan's name in ticker 130, either just to the left or just to the right of the fan's name, in some embodiments. Further alternatively or additionally, the driver's car number or name appears as “wall paper” on a portion of ticker 130 behind the fan's name. In such embodiments, a series of side by wall paper blocks having the driver name or number associated with the fan's name may scroll in ticker 130 with the associated fan's name shown prominently in each wall paper block. The favorite contestant information is among the information obtained from the subscriber when the subscriber subscribes using site 20 and is among the information stored in the various databases, such as database 60, of site 20.

In the FIG. 7 example, a driver running order ticker 132 appears at the top of screen 104 as is generally done in current racing broadcasts. A driver running order block 134 is shown just to the left of ticker 132 and a fan names block 136 is shown just to the left of ticker 130 in the illustrative FIG. 7 example. Blocks 134, 136, therefore, provide information to the viewers as to the type of name information being shown in each ticker 130, 132. While block 136 has the generic text “FAN NAMES” shown in FIG. 7, more colorful text may be included in block 136 at the discretion of the sports organizations. For example, terms like “Super Fans” or “NASCAR Nuts” or “IndyCar VIP's” or “PGA Patrons”, etc. may be used within the scope of this disclosure. The text in block 136, therefore, is intended to be complementary of the fans who have subscribed and to entice other fans to subscribe to have their name included on the ticker 130.

As indicated by diagrammatic arrows 138, 140 that are shown in FIG. 7 above ticker 132 and beneath ticker 130, the tickers 130, 132 can be scrolled in either direction 138, 140 at the discretion of the television broadcaster and/or sports organization. The speed at which tickers 138, 140 are scrolled may be the same in some embodiments and different in other embodiments. For example, most viewers will more likely be interested in the driving running order of a race than in the names of fans who have subscribed to be included on ticker 130. Thus, ticker 130 is scrolled at a faster rate than ticker 132 is scrolled in some embodiments. The reverse situation is also contemplated herein.

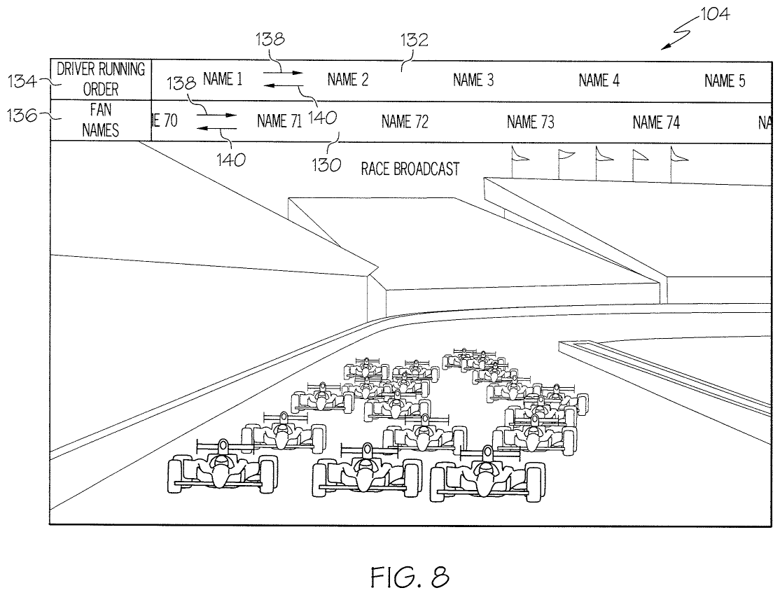

Referring now to FIG. 8, an example in which ticker 130 is shown just beneath ticker 132 at the top of screen 104 is shown. All other portions of FIG. 8 that are similar to like portions of FIG. 7 are indicated with like reference numbers. Thus, the discussion above regarding features and alternatives for FIG. 7 is also applicable to the FIG. 8 example. Of course, embodiments having one or two vertically oriented fan tickers for multi-contestant sports events, like races or golf tournaments, are also within the scope of this disclosure. Thus, the discussion above regarding features of tickers 100′, 102′ and the possibility for advertising blocks 120, 120′, is also applicable to multi-contestant sports although the need to bifurcate the fan tickers into a team 1 ticker and a team 2 ticker is no longer necessary.

During some race broadcasts and during some sporting events, the race or sporting event continues to be shown on screen 104 while television commercials are also broadcast. In such situations, the race or sports event generally takes up a third or fourth of the screen 104 adjacent to the commercial in a side-by-side arrangement. In some embodiments contemplated herein, the disclosed fan tickers, such as tickers 100, 100′, 102, 102′, 130, are suspended from being broadcast while the commercials and race (or sporting event) are being shown simultaneously in this manner because the fan names within the ticker may appear too small to reasonably be read by the viewers. However, this is not to say that continuing to broadcast the tickers with fan names on the race or sports event portion of the screen 104 isn't a possibility. To contrary, such embodiments are considered to be within the scope of this disclosure and, in fact, such embodiments would increase the number of available ticker slots for fans to subscribe.

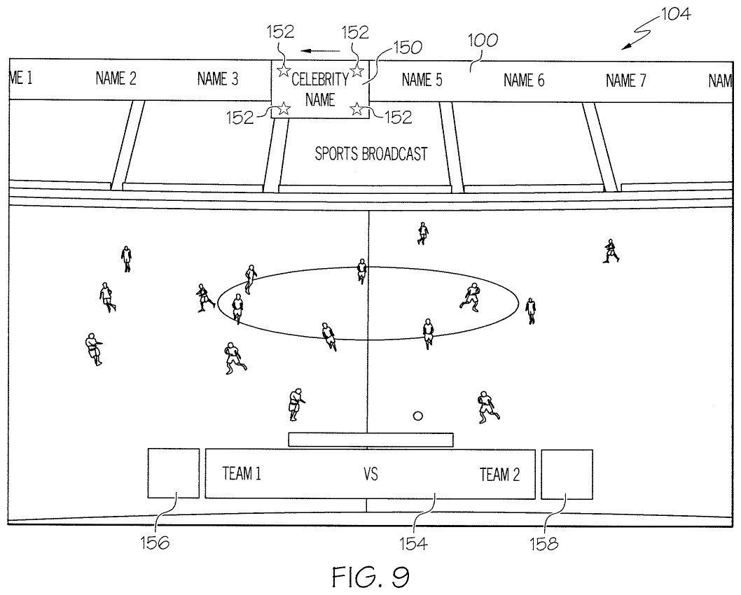

According to an aspect of this disclosure, different classes of subscriptions are offered on site 20 at different pricing levels. For example, celebrities may be wish to have their names included on one or more of tickers 100, 100′, 102, 102′, 130 and for their names to be shown more prominently than other fans included on the tickers. FIG. 9 shows an example in which a celebrity name block 150 is included as part of scrolling fan ticker 100 that appears at the top of screen 104. In the FIG. 9 example, only one ticker 100 is shown. Accordingly, this is an example in which a single ticker 100 shows the names of fan subscribers associated with a first team during part of the sports broadcast and will switch to showing the names of fan subscribers associated with a second team during a different part of the sports broadcast.

As is apparent in the FIG. 9 example, block 150 has a greater vertical height than the vertical height of the remainder of ticker 100. Block 150 also has a set of star indicia 152 to indicate to the viewers that the name within block 150 is that of a celebrity. It is contemplated by this disclosure that a celebrity subscription is considerably higher in price than a regular subscription for an individual in the general public. For example, a celebrity subscription price ten times that of a regular subscription is within the scope of this disclosure. That's not to say that other pricing multiples greater than or less than ten are not within the scope of this disclosure. Celebrities may be willing to pay the elevated price, for example, because it keeps their name in the public eye and also shows their loyalty to a particular team or sports league. It also educates that public as to which celebrities are fans of which sports teams or sports leagues. In other embodiments, celebrities may be offered subscriptions for free for the purpose of enticing others to pay for a subscription so that their name is included on the same fan ticker as the celebrity or celebrities.

In the FIG. 9 example, a team name block 154 is shown near the bottom of screen 104 with first and second score blocks 156, 158 in which the number of points of each respective team are shown. In some embodiments, when ticker 100 is scrolling the names of fans of team 1, the area of block 154 of team 1 is brightened or flashed or otherwise highlighted to indicate that the fan ticker 100 is showing the names of the subscribers of team 1's fans and then, when ticker switches to showing team 2's fans, the area of block 154 of team is highlighted in a similar manner.

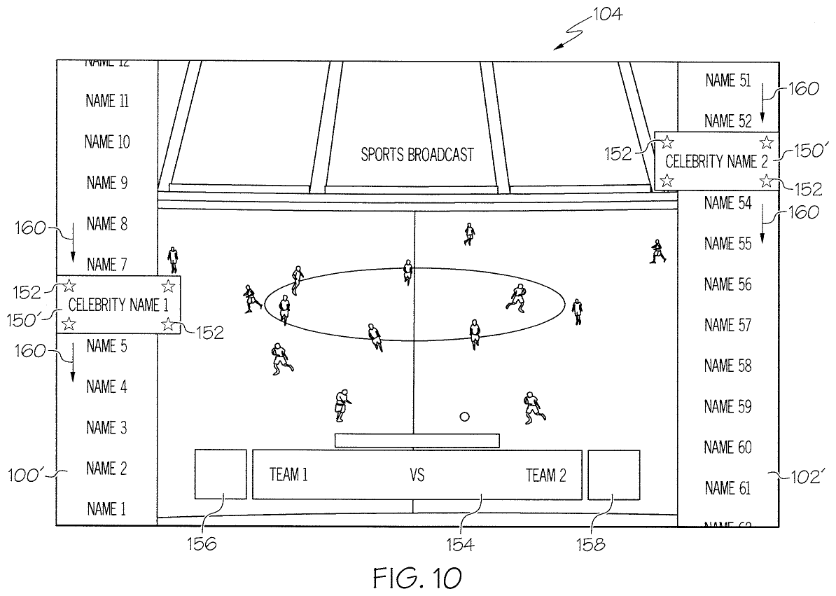

Referring to FIG. 10, an example having celebrity boxes 150′ shown on vertical tickers 100′, 102′ for first and second teams is provided. As indicated by arrows 160, tickers 100′, 102′ both scroll in the same direction in the FIG. 10 example. Other portions of the FIG. 10 example that are similar to like portions of the FIG. 9 example are indicated with like reference numbers and the discussion above regarding FIG. 9 is also applicable to the FIG. 10 example.

While FIGS. 9 and 10 illustrate the use of celebrity boxes 150, 150′ for different subscriber classes, other subscriber classes are within the scope of this disclosure. For example, members of a family may wish to have their names included together on the scrolling fan ticker but may not wish to pay for individual subscriptions having each of their names listed singly. Thus, in some embodiments, a family subscription is offered at a price that is more than the individual subscription price but not as much as the cost of having individual subscriptions. As an example, the text “John, Sue, and Jack Smith” may be included as a block of text as part of a family subscription that is, say, 1.5 times the price of an individual subscription. Of course, other family subscription multipliers greater than or less than 1.5 are within the scope of this disclosure.

As another example, organizations such as local businesses or fraternal organizations may wish to have their names included on the scrolling fan ticker. The pricing levels for such subscriptions may be at multiples less than the celebrity subscription price, but more than a regular subscription or family subscription. Furthermore, it is contemplated by this disclosure that some or all of the different subscription classes have respective indicia, similar to stars 152, in scrolling blocks, similar to block 150. In a college setting, for example, the fraternities and sororities of a school may wish to have their own subscription for the fan ticker. Local bars or restaurants may also be interested in having their name listed on the fan ticker. The indicia in the scrolling boxes may be logos provided by these organizations in some embodiments.

In those embodiments in which more than one class of subscription is offered on site 20, the databases 52, 54, 56, 58, 60 include a flag or identifier for each subscription to indicate its class. For example, the letter “r” (or “R”) may be used to identify regular subscriptions, the letter “c” (or “C”) may be used to identify a celebrity subscription, the letters “fo” or (“FO”) may be used to identify a fraternal organization subscription, and so on. Numerical codes or alphanumeric codes could be used just as well. These flags or identifiers may be included in a column of a spread sheet, for example. Programming to check for the flags and to add blocks 150 of the appropriate type with appropriate indicia, such as stars 152, in the appropriate slots in the ticker 100, 100′, 102, 102′, 130 is used during the broadcast.

Further according to this disclosure, fans are able to make partial or full donations to pay for a subscription of another person or organization to be included on a scrolling fan ticker. For example, those fans interested in paying for the subscription of a charitable organization are able to do so according to this disclosure. Once enough fans have made partial payments to cover the subscription cost of the person or organization, the associated name is added to the appropriate database of site 20. This approach is sometimes referred to as crowd funding. Accordingly, site 20 lists the persons and organizations that are eligible for having crowd funding pay for their fan ticker subscriptions.

In some embodiments, a sports league may host its own website that includes the same or similar functionality as site 20 such that the league manages its own fan tickers rather than having a third party provider perform the various tasks associated with obtaining and tracking the names to be included on the scrolling fan tickers. In some such embodiments, databases 22 and 26 are one in the same and the communication indicated by arrow 24 and the fee payment indicated by arrow 30 in FIG. 1 are omitted. The remaining discussion above is still applicable, however, even when a sports league or conference handles its own fan ticker activities.

In some embodiments, subscriptions are on a game-by-game basis although, more typically, a season long subscription is contemplated. Additional subscriptions with associated subscriptions fees are required for post season playoffs or tournaments in some embodiments. In other embodiments, the season long subscriptions also are used during post season tournaments or playoffs.

In a variant embodiment, fan tickers are subdivided into zones and then the names of subscribers are flashed of shown, one-at-a-time, in the zone. For example, horizontal tickers 100, 102, 130 are divided into fourths such that four, side-by-side zones are established within tickers 100, 102, 130. Each zone then shows fan names having last names that begin within certain letter ranges. For example, a first zone shows the names of subscriber having last names beginning with the letters A-F, a second zone shows subscribers having last names beginning with the letters G-M, a third zone shows the subscribers having last names beginning with the letters N-S, and the fourth zone shows the subscribers having last names beginning with the letters T-Z. In some embodiments, each name is shown within each zone for a short period of time (e.g., ½ second to a second) and then the next name is shown and so on. This sort of flashing from one name to the next within a zone of ticker 100, 102, 130 is still considered to be scrolling according to this disclosure. In other embodiments, the names may scroll vertically within these zones such that more than one name may be visible within a zone at any given time. In other embodiments, this sort of flashing or scrolling of names within a zone is done on vertical tickers 100′, 102′. In such embodiments, multiple names such as four or five, for example, may flash into each zone at a time of vertical tickers 100′, 102′ at time.

In some embodiments, the subscription for fans to be included on the scrolling fan tickers contemplated herein is included in the price of purchasing a season ticket or purchasing a VIP package of a sports league or some other such sports or television package. Including the fan ticker subscription with season tickets or packages provides further enticements for fans to purchase such season tickets or packages.

Although certain illustrative embodiments have been described in detail above, variations and modifications exist within the scope and spirit of this disclosure as described and as defined in the following claims.

1. A method comprising
storing in a database of a computer information pertaining to subscriptions of subscribers that have signed up to have the names of the subscribers displayed on a scrolling fan ticker during a sports broadcast,
providing to a television network a list of the names of the subscribers that are to be displayed on the scrolling fan ticker during the sports broadcast,
populating the database with information received from a sports organization pertaining to season ticket holders and offering the subscriptions only to the season ticket holders,
contacting the season ticket holders to offer subscriptions, wherein contacting the season ticket holders to offer subscriptions comprises at least one of the following: e-mailing at least some of the season ticket holders, text messaging at least some of the season ticket holders, calling at least some of the season ticket holders using a telephone, and mailing literature to at least some of the season ticket holders,
hosting a website that is used by subscribers to establish their subscriptions, and
providing on the website selectable fields for a plurality of sports organizations that are used by subscribers to establish their subscriptions.

2. The method of claim 1, wherein the sports organization comprises at least one of the following: a sports league, a sports association, or a sports team.

3. The method of claim 1, further comprising charging each of the subscribers for their subscriptions, paying the sports organization for the information pertaining to season ticket holders, and paying the television network to broadcast the list of names of the subscribers on the scrolling fan ticker.

4. The method of claim 1, further comprising charging each of the subscribers for their subscriptions and paying the television network to broadcast the list of names of the subscribers on the scrolling fan ticker.

5. The method of claim 1, wherein providing to the television network the list of the names of the subscribers that are to be displayed on the scrolling fan ticker during the sports broadcast comprises providing a first list of subscribers to be displayed on a first scrolling fan ticker associated with a first team of a sporting contest and comprising a second list of subscribers to be displayed on a second scrolling fan ticker associated with a second team of the sporting contest.

6. The method of claim 5, wherein the first and second lists of subscribers are provided to the television network in an electronic spread sheet with the first list being associated with a first tab of the spread sheet and the second list being associated with a second tab of the spread sheet.

7. The method of claim 1, wherein providing to the television network the list of the names of the subscribers that are to be displayed on the scrolling fan ticker during the sports broadcast comprises providing to the television network an electronic spread sheet with a plurality of tabs, each tab of the plurality of tabs of the spread sheet being selected to obtain the list of subscribers associated with a particular sports team of a sports league.

8. The method of claim 1, wherein the storing and the providing are performed by a governing entity of a sports league.

9. The method of claim 1, wherein the subscriptions are limited in number and further comprising auctioning the subscriptions based on bid amounts.

10. The method of claim 1, further comprising providing to at least one subscriber a still image showing the name of the subscriber as broadcast by the television network on the scrolling fan ticker during the sports broadcast.

11. The method of claim 10, wherein providing to at least one subscriber the still image comprises e-mailing the still image to the at least one subscriber.

12. The method of claim 10, wherein providing to at least one subscriber the still image comprises mailing a framed or mounted image that has been purchased by the at least one subscriber.

13. A method comprising
storing in a database of a computer information pertaining to subscriptions of subscribers that have signed up to have the names of the subscribers displayed on a scrolling fan ticker during a sports broadcast, and
providing to a television network a list of the names of the subscribers that are to be displayed on the scrolling fan ticker during the sports broadcast, wherein the subscriptions include a general subscription offered at a first amount and a premium subscription offered at a second amount, wherein the second amount is larger than the first amount, wherein the premium subscriptions are available for purchase by celebrities or fraternal organizations, and wherein the premium subscriptions each occupy a larger area on the scrolling fan ticker than is occupied by each of the general subscriptions.

14. The method of claim 13, further comprising storing in the database an electronic flag to indicate that an associated subscription is a celebrity subscription.

15. The method of claim 14, wherein the flag is provided to the television network along with the name of the celebrity so that the television network is able to use the flag to create the larger area on the scrolling fan ticker in which the associated celebrities' name appears.

16. The method of claim 13, further comprising storing in the database an electronic flag to indicate that an associated subscription is a fraternal organization subscription.

17. The method of claim 16, wherein the flag is provided to the television network along with the name of the fraternal organization so that the television network is able to use the flag to create the larger area on the scrolling fan ticker in which the associated fraternal organization's name appears.

18. A method comprising
storing in a database of a computer information pertaining to subscriptions of subscribers that have signed up to have the names of the subscribers displayed on a scrolling fan ticker during a sports broadcast, and
providing to a television network a list of the names of the subscribers that are to be displayed on the scrolling fan ticker during the sports broadcast, wherein the subscriptions include a general public subscription offered at a first amount and a premium subscription offered at a second amount, wherein the second amount is larger than the first amount, wherein the premium subscriptions occupy a larger area on the scrolling fan ticker,
populating the database with information received from a sports organization pertaining to season ticket holders and offering the subscriptions to the season ticket holders,
contacting the season ticket holders to offer subscriptions, wherein contacting the season ticket holders to offer subscriptions comprises at least one of the following: e-mailing at least some of the season ticket holders, text messaging at least some of the season ticket holders, calling at least some of the season ticket holders using a telephone, and mailing literature to at least some of the season ticket holders,
hosting a website that is used by subscribers to establish their subscriptions, and
providing to at least one subscriber a still image showing the name of the subscriber as broadcast by the television network on the scrolling fan ticker during the sports broadcast, wherein providing to at least one subscriber the still image comprises e-mailing the still image to the at least one subscriber or mailing a framed or mounted image that has been purchased by the at least one subscriber.
